(19) United States
(12) Patent Application Publication
(10) Pub. No.: US 2019/0094608 A1
(43) Pub. Date: Mar. 28, 2019

(54) Color Filter Substrate, Display Panel, Display Device And Method For Manufacturing the Color Filter Substrate

(71) Applicants: BOE Technology Group Co., Ltd., Beijing (CN); Chongqing BOE Optoelectronics Technology Co., Ltd., Chongqing (CN)

(72) Inventors: Bin WAN, Beijing (CN); Min LI, Beijing (CN); Ruilin BI, Beijing (CN); Yuanhong PENG, Beijing (CN); Xiongzhou WEI, Beijing (CN)

(21) Appl. No.: 16/023,357

(22) Filed: Jun. 29, 2018

(30) Foreign Application Priority Data
Sep. 26, 2017 (CN) 201710880422.6

(51) Int. Cl. G02F 1/1335; G02F 1/1343

(52) U.S. Cl. CPC G02F 1/133516; G02F 1/13394; G02F 1/133512; G02F 1/134309

(57) ABSTRACT

The present disclosure provides a color filter substrate, a display panel, a display device and a method for manufacturing the color filter substrate, the color filter substrate includes a first substrate, and a plurality of color resistances that are arranged in the same layer and connected with each other on the first substrate. The conductive material is mixed in the color resistances so that during operation of the display panel, the color resistance can not only pass the light of the corresponding color to form a color display, but also form a first electrode layer. Therefore, the structure of the color filter substrate is simplified, the production cost is reduced, and the contamination of liquid crystal molecules caused by the indium tin oxide particles is also correspondingly avoided, thereby improving the excellent rate of the display panel.

### CROSS-REFERENCE TO RELATED APPLICATION

This application claims a priority of Chinese Patent Application No. 201710880422.6 entitled with “Color Filter Substrate, Display Panel, Display Device And Method For Manufacturing the Color Filter Substrate” submitted on Sep. 26, 2017, the disclosure of which is incorporated herein in its entirety by reference.

### TECHNICAL FIELD

The present disclosure relates to the field of display technology, particularly to a color filter substrate, a display panel, a display device and a method for manufacturing the color filter substrate.

### BACKGROUND

Twisted Nematic (TN) type liquid crystal display panels are widely used in low—and—middle liquid crystal display devices due to their low production cost. The liquid crystal display panel includes an array substrate and a color filter substrate opposite to each other and a liquid crystal layer between the array substrate and the color filter substrate. The array substrate is provided with a pixel electrode, the color film substrate is provided with a common electrode, and the pixel electrode and the common electrode form an electric field by applying a driving voltage in order to drive deflection of the liquid crystal molecules, thereby controlling the light transmittance.

Due to the high transmittance and low resistivity of indium tin oxide (ITO), existing common electrodes are usually manufactured by forming a film of indium tin oxide.

### SUMMARY

The film of the indium tin oxide is formed by a magnetron sputtering process. During the formation of the film of the indium tin oxide, the indium tin oxide particles which would adhere to the surface of the color filter substrate are easily formed, and subsequently after the color filter substrate is aligned and assembled with the array substrate to form a cell, the liquid crystal molecules are easily contaminated. As a result, an excellent rate of the display panel is low.

Therefore, in order to overcome the above problem, the present disclosure provides a color filter substrate, including: a first substrate, and a plurality of color resistances on the first substrate, the color resistances are arranged in the same layer and connected with each other, wherein the color resistance comprises a conductive material, and the color resistance is formed as a first electrode layer.

Optionally, the conductive material is a conjugated macromolecule polymer material.

Optionally, the conjugated macromolecule polymer material includes polyacetylene, polypyrrole, polyparaphenylene vinylene, polyphenylene sulfide, polyaniline, polythiophene, polyparaphenylene, or any combination thereof.

Optionally, the color resistance includes a first color resistance, a second color resistance, and a third color resistance, the first color resistance is a red color resistance, the second color resistance is a blue color resistance, and the third color resistance is a green color resistance.

Optionally, the color filter substrate further includes a black matrix that is located on a side of the color resistance away from the first substrate and located between the adjacent color resistances.

Optionally, the color filter substrate further includes a plurality of spacers that are located on a side of the black matrix away from the first substrate.

The present disclosure also provides a display panel, including: an array substrate, the color filter substrate as described above, and a liquid crystal layer that is located between the array substrate and the color filter substrate opposite to each other.

Optionally, the array substrate includes a second substrate and a second electrode on the second substrate, the second electrode is located on a side of the second substrate adjacent to the first substrate, the second electrode and the first electrode layer are configured to drive deflection of liquid crystal molecules in the liquid crystal layer.

The present disclosure also provides a display device including the display panel as described above.

The present disclosure also provides a method for manufacturing the color filter substrate, including:

providing a first substrate,

mixing a conductive material with a color resistance material to form a conductive mixture, the color resistance material comprises a resin;

mixing the conductive mixture with a solvent to form a conductive color resistance solution;

applying the color resistance solution on the first substrate, and forming a plurality of color resistances on the first substrate by a patterning process, the color resistances are arranged in the same layer and connected with each other.

Optionally, a mass percentage of the conductive material in the color resistance solution is 10%-20%.

Optionally, after forming the plurality of color resistances on the first substrate, the method for manufacturing a color filter substrate further includes:

applying a black matrix solution on the first substrate on which the plurality of color resistances are formed, and forming a plurality of black matrixes by a patterning process, wherein the plurality of black matrixes are located between the adjacent color resistance, respectively.

The present disclosure has the following beneficial effects:

The present disclosure provides a color filter substrate, a display panel, a display device and a method for manufacturing the color filter substrate, wherein the color filter substrate includes a first substrate, and a plurality of color resistances on the first substrate, and the color resistances are arranged in the same layer and connected with each other. The conductive material is mixed in the color resistances so that during operation of the display panel, the color resistance can not only pass a light of the corresponding color to form a color display, but also form a first electrode layer to replace the existing common electrode made of the indium tin oxide material. Thus, there is no need to additionally provide a common electrode, thereby simplifying the structure of the color filter substrate, reducing the production costs and correspondingly avoiding the contamination of liquid crystal molecules caused by indium tin oxide particles, and further improving the excellent rate of the display panel.

### BRIEF DESCRIPTION OF THE FIGURES

FIG. 1 is a schematic diagram showing a color filter substrate according to some examples of the present disclosure;

FIG. 2 is a schematic diagram showing a display panel according to some examples of the present disclosure;

FIG. 3 is a flow chart showing a method for manufacturing the color filter substrate according to some examples of the present disclosure;

FIG. 4 is a schematic diagram showing the first color resistance, the second color resistance and the third color resistance formed on the first substrate according to some examples of the present disclosure;

FIG. 5 is a schematic diagram showing formation of black matrixes according to some examples of the present disclosure;

FIG. 6 is a schematic diagram showing formation of a spacers according to some examples of the present disclosure;

### DETAILED DESCRIPTION

In order to enable those skilled in the art to better understand the technical solutions of the present disclosure, a color filter substrate, a display panel, a display device and a method for manufacturing a color filter substrate provided by the present disclosure will be further described in detail with reference to the drawings.

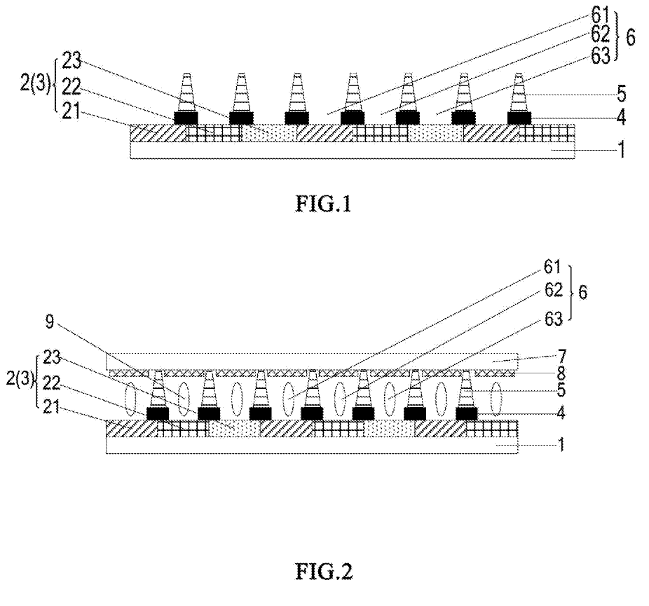

Some examples of the present disclosure provide a color filter substrate. As shown in FIG. 1, the color filter substrate includes: a first substrate 1, and a plurality of color resistances 2 on the first substrate 1, the color resistances 2 are arranged in the same layer and connected with each other, each of the color resistances 2 includes a conductive material, and each of the color resistances 2 is formed as a first electrode layer 3.

Specifically, each of the color resistances 2 can pass a light of a specific color, each of the color resistances 2 can conduct electricity, and the first electrode layer 3 formed by connecting each of the color resistances 2 with each other can also conduct electricity.

For the color filter substrate provided by the example of the present disclosure, the conductive material is mixed in each of the color resistances 2 so that during the operation of the display panel, each of the color resistances can not only pass the light of the corresponding color to form a color display, but also form a first electrode layer 3 to replace the existing common electrode made of the indium tin oxide material. Thus, there is no need to additionally provide a common electrode, thereby simplifying the structure of the color filter substrate, reducing the production costs and correspondingly avoiding the contamination of liquid crystal molecules caused by indium tin oxide particles, and further improving the excellent rate of the display panel.

It should be noted that the material of color resistances 2 includes resin material and pigments, the pigments is uniformly dispersed in the resin material, and pigments of different colors are mixed in the resin material to form the color resistances 2 of different colors.

Preferably, the conductive material is a conjugated macromolecule polymer material. Since the conjugated macromolecule polymer has π electrons that can move freely, the conjugated macromolecule polymer has good conductivity, and the conductive effect of the first electrode layer 3 can be better improved. Moreover, the conjugated macromolecule polymer material has good compatibility with the resin material and does not react with the resin material and the pigments. Thus, the conjugated macromolecule polymer material not only facilitates the formation of the first electrode layer 3 but also does not affect the filter effect of the color resistances 2.

Further preferred conjugated macromolecule polymer material includes

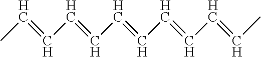

(polyacetylene),

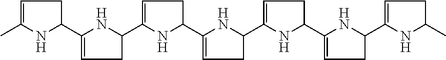

(polypyrrole),

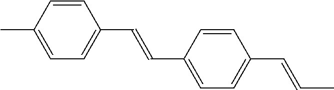 [SMILES: C/C=C/c1ccc(/C=C/c2ccc(C)cc2)cc1]

(polyparaphenylene vinylene), polyphenylene sulfide,

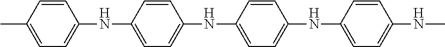

(polyaniline),

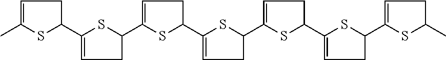

(polythiophene), or

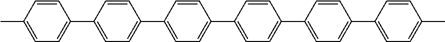

(polyparaphenylene). Since the conjugated macromolecule polymer material described above has many π electrons that can move freely, the conductive effect of the first electrode layer 3 can be further improved. Of course, those skilled in the art know that any conjugated macromolecule polymer material that may be mixed with the material of the color resistances 2 to make the first electrode layer 3 have better conductivity is within the protection scope of the present disclosure.

The specific structure of the color filter substrate provided in the example of the present disclosure will be described in detail below with reference to FIG. 1.

As shown in FIG. 1, the color resistances 2 include a first color resistance 21, a second color resistance 22, and a third color resistance 23, the first color resistance 21 may be a red color resistance, the second color resistance 22 may be a blue color resistance, and the third color resistance 23 may be a green color resistance.

As shown in FIG. 1, the color filter substrate may further include black matrixes 4 that are located on a side of the color resistances 2 away from the first substrate 1 and located between the adjacent color resistances 2.

In the existing color filter substrate, the black matrix is usually located on the side of the color resistances adjacent to the substrate, and partially overlaps with the color resistances. Since the black matrix has a certain thickness, it causes a certain step difference at the position where the color resistances lap the black matrix. In the process of applying the alignment layer on the surface of the color resistances, the step difference easily causes the alignment layer to be coated abnormally, thereby affecting the deflection of the liquid crystal molecules during the operation of the display panel, and further affecting the display effect of the display screen. Although it is possible to apply a planarization layer on the surface of the color resistances to avoid abnormality in the alignment layer coating, an additional planarization layer is required, which results in a complicated structure of the color filter substrate and a high manufacturing cost.

In order to improve the display effect of the display screen without additionally increasing the film layer structure, as shown in FIG. 1, in the color filter substrate provided in the examples of the present disclosure, the black matrix 4 is located on the side of the color resistances 2 away from the first substrate 1 and is located between the adjacent color resistances 2. Specifically, the black matrix 4 is located between the adjacent sub-pixel units so that a light is blocked to improve the contrast of the display screen. In the process of applying the alignment layer on the surface of the color resistances 2, since there is no step difference on the surface of the color resistances 2, it is possible to avoid abnormality of the alignment layer coating. Therefore, the display effect of the display screen can be improved without additionally providing a planarization layer.

It should be noted that the alignment layer is applied after the black matrix 4 is formed on the first substrate 1. Although the alignment layer is likely to be abnormally coated at the position of the black matrix 4, the display effect of the display screen is not affected because the light cannot pass through the area of the black matrix 4.

Preferably, an optical density (OD) value of the material of the black matrix 4 is greater than or equal to 4, so that a contrast of the display screen can be better improved.

Further, as shown in FIG. 1, the color filter substrate may further include a plurality of spacers 5 located on a side of the black matrix 4 away from the first substrate 1. After the color filter substrate is aligned and assembled with the array substrate to form a cell, the spacers 5 are used to support the cell thickness between the color filter substrate and the array substrate.

An example of the present disclosure also provides a display panel, as shown in FIG. 2, the display panel includes an array substrate, the color filter substrate as described above and a liquid crystal layer 9, the array substrate is aligned with the color filter substrate by a cell process and the liquid crystal layer 9 is located between the array substrate and the color filter substrate.

The display panel may include a plurality of pixel units 6 arranged in a matrix, the pixel unit 6 may include a first sub-pixel unit 61, a second sub-pixel unit 62, and a third sub-pixel unit 63 disposed in sequence, the first sub-pixel unit 61 may include a first color resistance 21, the second sub-pixel unit 62 may include a second color resistance 22, the third sub-pixel unit 63 may include a third color resistance 23. The first color resistance 21, the second color resistance 22 and the third color resistance 23 are provided in the same layer and are connected with each other to form the first electrode layer 3. During the operation of the display panel, the first color resistance 21 enables the first sub-pixel unit 61 to emit red light, the second color resistance 22 enables the second sub-pixel unit 62 to emit blue light, the third color resistance 23 enables the third sub-pixel unit 63 to emit green light, the red light, blue light, and green light of different light intensities are combined to form pixel points of the corresponding color, and a plurality of pixels can form a corresponding color display screen.

It should be noted that the first sub-pixel unit 61 includes the first color resistance 21, the second sub-pixel unit 62 includes the third color resistance 23, the third sub-pixel unit 63 includes the second color resistance 22; alternatively, the first sub-pixel unit 61 includes the second color resistance 22, the second sub-pixel unit 62 and the third sub-pixel unit 63 include the first color resistance 21 and the third color resistance 23, respectively; alternatively, it is also feasible that the first sub-pixel unit 61 includes the third color resistance 23, the second sub-pixel unit 62 and the third sub-pixel unit 63 include the first color resistance 21 and the second color resistance 22, respectively.

The array substrate includes a second substrate 7 and a second electrode 8 formed on the second substrate 7, the second electrode 8 is located on the side of the second substrate 7 adjacent to the first substrate 1, the second electrode 8 and the first electrode layer 3 are used to drive the deflection of liquid crystal molecules in the liquid crystal layer 9. Specifically, the second electrode 8 and the first electrode layer 3 in the sub-pixel unit drive the deflection of the liquid crystal molecules in the liquid crystal layer 9 to control the intensity of the light emitted from the sub-pixel unit.

Some examples of the present disclosure also provide a display device including the display panel as described above. The display device may be any product or component that has a liquid crystal display function, such as an electronic paper, a mobile phone, a tablet computer, a television, a digital photo frame, and the like.

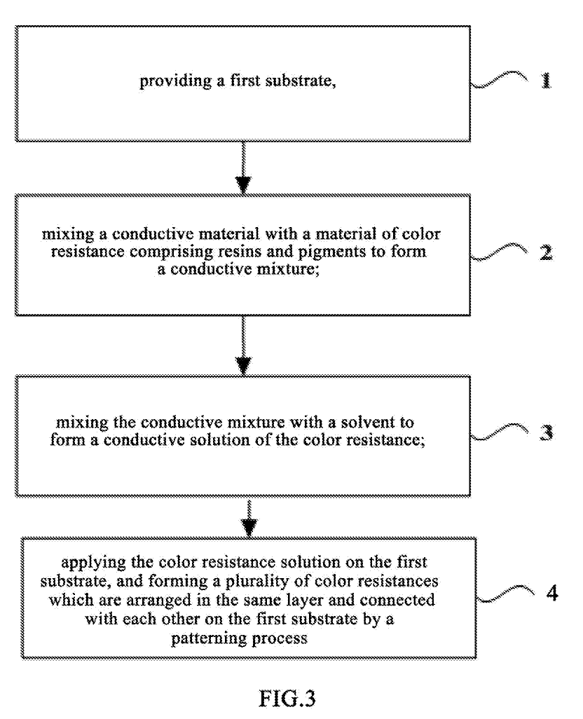

Some examples of the present disclosure also provide a method for manufacturing the color filter substrate, which is used for manufacturing the above color filter substrate. As shown in FIG. 3, the method for manufacturing the color filter substrate includes:

Step 1, providing a first substrate,

Step 2, mixing a conductive material with a material of the color resistances 2 to form a conductive mixture.

Specifically, the material of the color resistances 2 may include an organic resin, and the conductive material may be uniformly dispersed in the organic resin by means of mechanical stirring or ultrasonic dispersion. And the conductive material may be a metal nanoparticle or a conjugated macromolecule polymer.

Step 3, mixing the conductive mixture with a solvent to form a conductive solution of the color resistance 2.

Specifically, the conductive mixture may be uniformly mixed with the solvent by means of mechanical stirring or ultrasonic dispersion, the solvent may include a pigment paste, and the solutions of the color resistances 2 of different colors are formed by mixing pigment pastes of different colors in the solvent.

Preferably, the conductive material accounts for 10%-20% by mass of the color resistance 2 solution. In this way, the conductive property of the color resistances 2 can be more improved.

Step 4, applying the solution of the color resistances 2 on the first substrate 1, and forming a plurality of color resistances 2 that are arranged in the same layer and connected with each other on the first substrate by a patterning process.

Specifically, after the solution of the color resistance 2 is applied on the first substrate 1, the solution of the color resistance 2 may be exposed by using a mask, and after development, a corresponding pattern of the color resistance 2 may be formed.

In the method for manufacturing the color filter substrate provided by an example of the present disclosure, the conductive solution of the color resistance 2 is formed by firstly mixing the conductive material with the material of the color resistances 2, and then mixing the material of color resistances 2 comprising the conductive material with the solvent. Finally, the solution of the color resistances 2 is applied on the first substrate 1, and a pattern of the color resistances 2 is formed through a patterning process so that the color resistances 2 can conduct electricity. During the operation of the display panel, the color resistances 2 can not only pass the light of the corresponding color to form a color display, but also form a first electrode layer 3 to replace the existing common electrode made of the indium tin oxide material. Thus, there is no need to additionally provide a common electrode, thereby simplifying the structure of the color filter substrate, reducing the production costs and correspondingly avoiding the contamination of liquid crystal molecules caused by indium tin oxide particles, and further improving the excellent rate of the display panel.

In order to clearly illustrate the manufacturing method of the color filter substrate provided by the present example, the color resistances 2 including the first color resistance 21, the second color resistance 22, and the third color resistance 23 will be taken as an example to describe in detail the manufacturing method of the color filter substrate.

As shown in FIG. 4, the method for manufacturing the color filter substrate includes the following steps:

forming the first color resistance 21, the second color resistance 22, and the third color resistance 23 respectively on the first substrate 1 by steps 1 to 4 in sequence, wherein the first color resistance 21, the second color resistance 22, and the third color resistance 23 are disposed in the same layer and are connected with each other to form the first electrode layer 3.

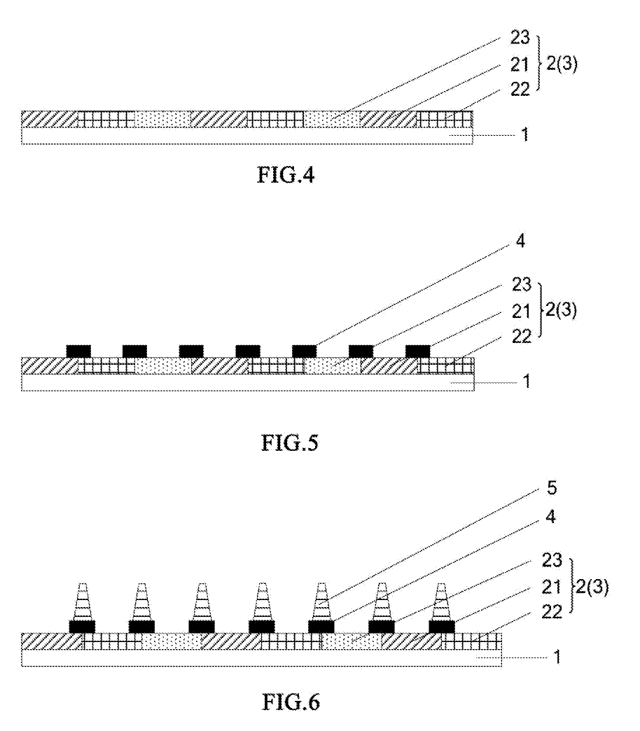

As shown in FIG. 5 and FIG. 6, the method further includes the following steps:

applying a solution of the black matrix 4 on the first substrate 1 on which a plurality of the color resistances 2 is formed, and forming a plurality of black matrixes 4 by a patterning process, wherein the plurality of black matrixes 4 are located between the adjacent color resistance 2, respectively. And a solution of spacer 5 is applied on the first substrate 1 on which the plurality of black matrixes 4 are formed, and a plurality of spacers 5 is formed by the patterning process, wherein the plurality of spacers 5 are located on the side of the black matrixes 4 away from the first substrate 1.

It can be understood that the above embodiments are merely exemplary embodiments employed for illustrating the principle of the present disclosure, but the present disclosure is not limited thereto. For a person skilled in the art, various variations and modifications may be made without departing from the spirit and essence of the present disclosure, and these variations and modifications are also considered to be within the protection scope of the present disclosure.

### REFERENCE SIGNS

1, A first substrate; 2, A color resistance; 21, A first color resistance; 22, A second color resistance; 23, A third color resistance; 3, A first electrode layer; 4, A black matrix; 5, the spacer; 6, A pixel unit; 61, A first sub-pixel unit; 62, A second sub-pixel unit; 63, A third sub-pixel unit; 7, A second substrate; 8, A second electrode; 9, A liquid crystal layer.

1. A color filter substrate, including:
a first substrate, and
a plurality of color resistances on the first substrate, which are arranged in the same layer and connected with each other, wherein the color resistance includes a conductive material, and the color resistance is formed as a first electrode layer.

2. The color filter substrate according to claim 1, wherein the conductive material is a conjugated macromolecule polymer material.

3. The color filter substrate according to claim 2, wherein the conjugated macromolecule polymer material is selected from polyacetylene, polypyrrole, polyparaphenylene vinylene, polyphenylene sulfide, polyaniline, polythiophene, polyparaphenylene, or any combination thereof.

4. The color filter substrate according to claim 1, wherein the color resistance includes a first color resistance, a second color resistance, and a third color resistance, the first color resistance is a red color resistance, the second color resistance is a blue color resistance, and the third color resistance is a green color resistance.

5. The color filter substrate according to claim 1, further including a black matrix that is located on a side of the color resistance away from the first substrate and located between the adjacent color resistances.

6. The color filter substrate according to claim 5, further including a plurality of spacers that are located on a side of the black matrix away from the first substrate.

7. A display panel, including
an array substrate,
the color filter substrate according to claim 1, and
a liquid crystal layer that is located between the array substrate and the color filter substrate opposite to each other;
wherein the array substrate includes a second substrate and a second electrode on the second substrate, the second electrode is located on a side of the second substrate adjacent to the first substrate, the second electrode and the first electrode layer are configured to drive deflection of liquid crystal molecules in the liquid crystal layer.

8. A display panel, including
an array substrate,
the color filter substrate according to claim 3, and
a liquid crystal layer that is located between the array substrate and the color filter substrate opposite to each other;
wherein the array substrate includes a second substrate and a second electrode on the second substrate, the second electrode is located on a side of the second substrate adjacent to the first substrate, the second electrode and the first electrode layer are configured to drive deflection of liquid crystal molecules in the liquid crystal layer.

9. A display panel, including
an array substrate,
the color filter substrate according to claim 4, and
a liquid crystal layer that is located between the array substrate and the color filter substrate opposite to each other;
wherein the array substrate includes a second substrate and a second electrode on the second substrate, the second electrode is located on a side of the second substrate adjacent to the first substrate, the second electrode and the first electrode layer are configured to drive deflection of liquid crystal molecules in the liquid crystal layer.

10. A display panel, including
an array substrate,
the color filter substrate according to claim 5, and
a liquid crystal layer that is located between the array substrate and the color filter substrate opposite to each other;
wherein the array substrate includes a second substrate and a second electrode on the second substrate, the second electrode is located on a side of the second substrate adjacent to the first substrate, the second electrode and the first electrode layer are configured to drive deflection of liquid crystal molecules in the liquid crystal layer.

11. A display panel, including
an array substrate,
the color filter substrate according to claim 6, and
a liquid crystal layer that is located between the array substrate and the color filter substrate opposite to each other;
wherein the array substrate includes a second substrate and a second electrode on the second substrate, the second electrode is located on a side of the second substrate adjacent to the first substrate, the second electrode and the first electrode layer are configured to drive deflection of liquid crystal molecules in the liquid crystal layer.

12. A display device, including the display panel according to claim 7.

13. A method for manufacturing a color filter substrate, including:
providing a first substrate,
mixing a conductive material with a color resistance material to form a conductive mixture, the color resistance material comprises a resin;
mixing the conductive mixture with a solvent to form a conductive color resistance solution;
applying the color resistance solution on the first substrate, and forming a plurality of color resistances on the first substrate by a patterning process, the color resistances are arranged in the same layer and connected with each other.

14. The method for manufacturing a color filter substrate according to claim 13, wherein a mass percentage of the conductive material in the color resistance solution is 10%-20%.

15. The method for manufacturing a color filter substrate according to claim 13, further including:
applying a black matrix solution on the first substrate on which the plurality of color resistances are formed, and forming a plurality of black matrixes by a patterning process after forming the plurality of color resistances on the first substrate, wherein the plurality of black matrixes are located between the adjacent color resistances, respectively.
